(19) United States
(12) Patent Application Publication
(10) Pub. No.: US 2008/0068865 A1
(43) Pub. Date: Mar. 20, 2008

(54) ASYMMETRICAL DIRECT CURRENT TO DIRECT CURRENT CONVERTER USING NAND GATE

(76) Inventors: Do-Wan Kim, Suwon-si (KR); Hee-Hwan Kim, Suwon-si (KR); Chul-Su Hong, Suwon-si (KR); Chong-Eun Kim, Suwon-si (KR); Gun-Woo Moon, Suwon-si (KR)

Correspondence Address: CHRISTIE, PARKER & HALE, LLP, PO BOX 7068, PASADENA, CA, 91109-7068, US

(21) Appl. No.: 11/691,435

(22) Filed: Mar. 26, 2007

(30) Foreign Application Priority Data
Sep. 14, 2006 (KR) 10-2006-0089266

(51) Int. Cl. H02M 3/335

(52) U.S. Cl. 363/17

(57) ABSTRACT

An asymmetrical DC to DC converter using one or more NAND gates. In one embodiment, an asymmetrical DC to DC converter includes a converter unit including a switching unit and adapted to transform a first voltage having a first level to a second voltage having a second level according to a switching operation of the switching unit and an output voltage control unit including at least one NAND gate and adapted to control the second level of the second voltage to be substantially uniform. The output voltage control unit is further adapted to generate a driving signal for the switching unit via the at least one NAND gate. As such, an asymmetrical control circuit that is suitable for an asymmetrical half bridge converter or an active clamp converter can be simply and inexpensively realized using a NAND gate instead of using expensive dedicated chips.

### CROSS-REFERENCE TO RELATED PATENT APPLICATION

This application claims priority to and the benefit of Korean Patent Application No. 10-2006-0089266, filed on Sep. 14, 2006, in the Korean Intellectual Property Office, the entire content of which is incorporated herein by reference.

### BACKGROUND OF THE INVENTION

1. Field of the Invention

The present invention relates to an asymmetrical direct current to direct (DC to DC) current converter.

2. Description of the Related Art

Given the recent demand for small, lightweight, and high efficiency power supply apparatuses, a conventional pulse width modulation (PWM) converter has been replaced by a resonant converter, a quasi-resonant converter, a multi-resonant converter, or a soft switching converter. The hard-switching operation of the conventional PWM converter causes switching loss, noise, or switching stress, and these problems are more severe during a high frequency operation.

In order to address these problems, a few resonant techniques have been applied to the PWM converter. In general, resonant converters include series type, parallel type, and class-E type quasi-resonant converters, and multi-resonant converters. Control techniques for resonant converters are divided into zero voltage switching (ZVS) and zero current switching (ZCS) techniques in relation with current methods. Using these techniques, switching loss and other effects of hard-switching can be greatly reduced.

A sustain power supply apparatus for a plasma display device is one of the apparatuses consuming the most power in a plasma display device. Accordingly, the power supply apparatus should be optimized with respect to circuit efficiency, cost, number of parts, and stress. For this reason, an asymmetrical half-bridge circuit or an active clamp circuit is used as a power supply apparatus for a plasma display device.

Dedicated chips, which can be purchased, are used to control the asymmetrical half-bridge converter or the active clamp forward converter. Examples of dedicated chips are UC3715 which is produced by Texas Instruments Co., UCC3580 (Texas Instruments) combined with a PWM control circuit, and IR21844 (International Rectifier Corp.) combined with a floating gate driver.

Asymmetrical gate signals of the asymmetrical half-bridge converter or the active clamp forward converter can be simply generated by dedicated asymmetrical chips. However, the dedicated asymmetrical chips are expensive, thereby increasing manufacturing costs.

### SUMMARY OF THE INVENTION

An aspect of the present invention is directed to an asymmetrical direct current to direct current (DC to DC) converter in which an asymmetrical control circuit that is suitable for a DC to DC converter such as an asymmetrical half-bridge converter or an active clamp forward converter can be realized by using a NAND gate instead of using expensive dedicated asymmetrical chips.

According to an exemplary embodiment of the present invention, an asymmetrical DC to DC converter includes a converter unit including a switching unit and adapted to transform a first voltage having a first level to a second voltage having a second level according to a switching operation of the switching unit and an output voltage control unit including at least one NAND gate and adapted to control the second level of the second voltage to be substantially uniform. The output voltage control unit is further adapted to generate a driving signal for the switching unit via the at least one NAND gate.

The switching unit may include at least one switching device connected to a voltage source for providing the first voltage. The converter unit may further include a conversion unit including a transformer adapted to change the first level of the first voltage to generate a changed voltage, and a rectifying unit adapted to generate the second voltage by rectifying the changed voltage.

The at least one switching device of the switching unit may include a first switch configured to connect the voltage source for providing the first voltage and the transformer by its ON operation and a second switch configured to form a current loop with the transformer by its ON operation.

The switching unit may further include a resonant capacitor connected to a primary side of the transformer such that the at least one switching device of the switching unit can be zero voltage switched in resonance with an equivalent inductor of the primary side of the transformer.

The primary side of the transformer may be connected to the switching unit, and a secondary side of the transformer may be connected to the rectifying unit.

The output voltage control unit may further include: an output voltage detecting unit adapted to detect the second voltage outputted from the converter unit and to provide a voltage; a PWM control unit adapted to generate a PWM control value in response to the voltage provided by the output voltage detecting unit; and a gate signal generation unit including the at least one NAND gate and adapted to generate the driving signal for the switching unit in response to the PWM control value.

The output voltage detecting unit may be further adapted to electrically isolate the voltage provided by the output voltage detecting unit from the second voltage outputted from the converter unit.

The at least one switching device of the switching unit may include a first switch configured to connect a voltage source for providing the first voltage and the transformer by its ON operation and a second switch configured to form a current loop with the transformer by its ON operation. The driving signal may be configured to be asymmetrically inputted to the first switch and the second switch.

The driving signal may have a plurality of dead times during which ON signals for the first switch do not overlap with ON signals for the second switch.

The at least one NAND gate of the gate signal generation unit may include a first gate and a second gate each adapted to receive the PWM control value and a third gate adapted to receive an output of the second gate, and the first gate, the second gate, and the third gate may be NAND gates. Input terminals of the first gate and the second gate may be adapted to receive the PWM control value, and two input terminals of the third gate may be adapted to receive the output of the second gate.

An output of the first gate may be the second driving signal for the second switch, and an output of the third gate may be the first driving signal for the first switch.

The gate signal generation unit may further include a first resistor connected between an input terminal of the gate signal generation unit and the input terminals of the first gate and a second resistor connected between the input terminal of the gate signal generation unit and one of the input terminals of the second gate. The gate signal generation unit may further include a first capacitor connected between a ground terminal and both the first resistor and the input terminals of the first gate and a second capacitor connected between the ground terminal and both the second resistor and the one of the input terminals of the second gate.

According to another exemplary embodiment of the present invention, an asymmetrical DC to DC converter includes: a converter unit including a switching unit and a half-bridge converter, and adapted to transform a first voltage having a first level to a second voltage having a second level according to a switching operation of the switching unit; and an output voltage control unit including at least one NAND gate and adapted to control the second level of the second voltage to be substantially uniform. The output voltage control unit is further adapted to generate a driving signal for the switching unit via the at least one NAND gate.

According to yet another exemplary embodiment of the present invention, an asymmetrical DC to DC converter includes: a converter unit including a switching unit and an active clamp converter, and adapted to transform a first voltage having a first level to a second voltage having a second level according to a switching operation of the switching unit; and an output voltage control unit including at least one NAND gate and adapted to control the second level of the second voltage to be substantially uniform. The output voltage control unit is further adapted to generate a driving signal for the switching unit via the at least one NAND gate.

According to embodiments of the present invention, an asymmetrical control circuit, which is suitable for a DC to DC converter such as an asymmetrical DC to DC converter or an active clamp converter, can be simply and inexpensively realized using a NAND gate instead of expensive dedicated chips.

### BRIEF DESCRIPTION OF THE DRAWINGS

The above and other aspects and features of the present invention will become more apparent by describing in detail exemplary embodiments thereof with reference to the attached drawings in which:

FIG. 1 is a schematic drawing of an asymmetrical gate signal generation circuit for an asymmetrical half-bridge converter or an active clamp forward converter using an asymmetrical excusive chip UC3715 for asymmetrical control;

FIG. 2 is a schematic drawing illustrating an asymmetrical DC to DC converter that uses a NAND gate and includes a single condenser type half-bridge converter, according to an embodiment of the present invention;

FIG. 3 is a schematic drawing illustrating an asymmetrical DC to DC converter, according to a further embodiment of the present invention;

FIG. 4 is a schematic drawing illustrating a gate signal generation unit in the asymmetrical DC to DC converter of FIGS. 2 and 3;

FIG. 5 is a timing diagram illustrating the principle of generating two asymmetrical gate signals in the asymmetrical DC to DC converter of FIGS. 2 and 3;

FIG. 6 is a schematic drawing illustrating an asymmetrical DC to DC converter that uses a NAND gate and includes a two-condenser type half-bridge converter, according to another embodiment of the present invention; and

FIG. 7 is a schematic drawing illustrating an asymmetrical DC to DC converter that uses a NAND gate and includes an active clamp converter, according to another embodiment of the present invention.

### DETAILED DESCRIPTION

The present invention will now be described more fully with reference to the accompanying drawings in which exemplary embodiments of the invention are shown.

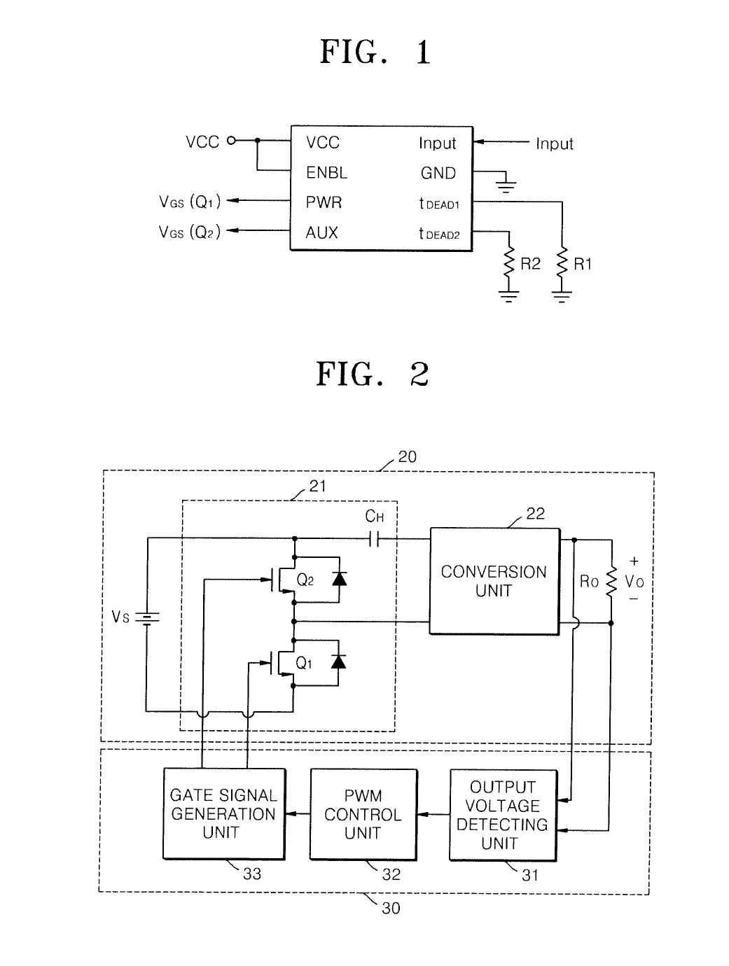

FIG. 1 is a schematic drawing of an asymmetrical gate signal generation circuit for an asymmetrical half-bridge converter or an active clamp forward converter using the dedicated chip UC3715 for asymmetrical control.

Referring to FIG. 1, the magnitude of a dead time between two gate signals (i.e., a time in which logic high pulses of the two gate signals are not overlapping) is determined according to the values of two resistors R1 and R2. Accordingly, when various types of dedicated asymmetrical chips including the UC3715 are used, asymmetrical gate signals for the asymmetrical half-bridge converter or the active clamp forward converter can be simply generated.

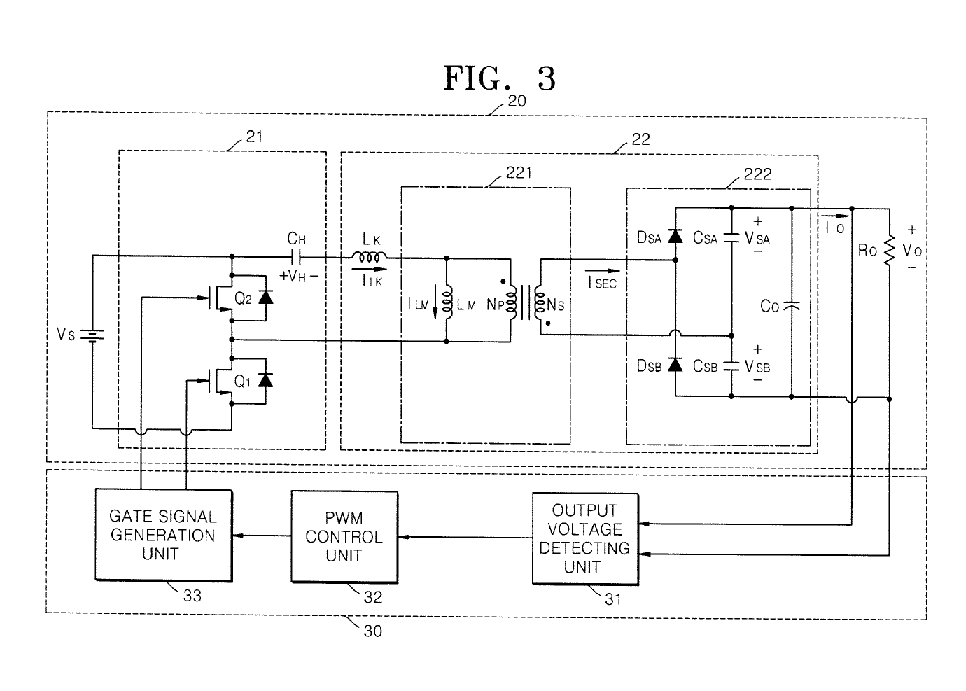

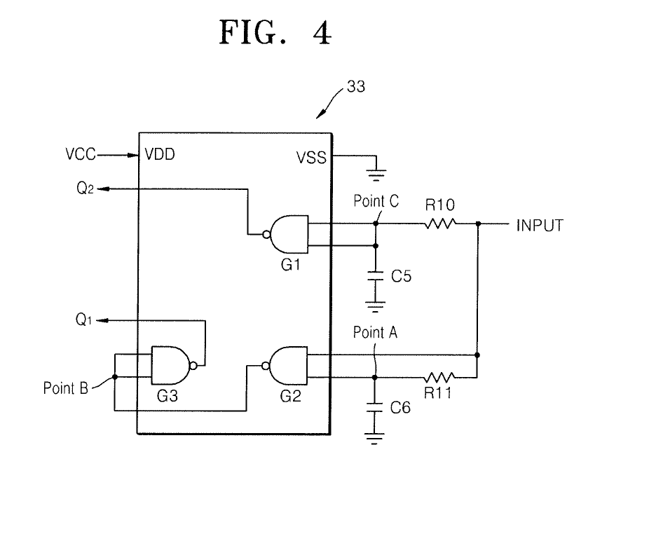

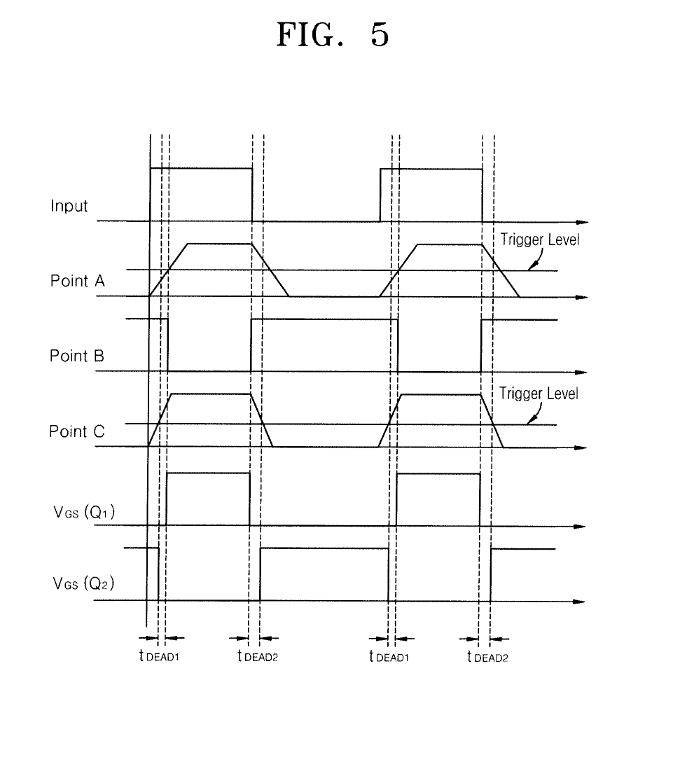

FIG. 2 is a schematic drawing illustrating an asymmetrical DC to DC converter that uses a NAND gate and includes a single condenser type half-bridge converter, according to an embodiment of the present invention. FIG. 3 is a schematic drawing illustrating an asymmetrical DC to DC converter according to a further embodiment of the present invention. FIG. 4 is a schematic drawing illustrating a gate signal generation unit in the asymmetrical DC to DC converter of FIGS. 2 and 3. FIG. 5 is a timing diagram illustrating the principle of generating two asymmetrical gate signals in the asymmetrical DC to DC converter of FIGS. 2 and 3.

Referring to FIGS. 2, 3, 4 and 5, an asymmetrical DC to DC converter that uses one or more NAND gates, according to embodiments of the present invention, includes a converter unit 20 and an output voltage control unit 30. The converter unit 20 converts a first voltage Vs of a first level to a second voltage Vo of a second level by (or according to) a switching operation of a switching unit 21. The output voltage control unit 30 maintains the level of the second voltage Vo to be constant (or substantially uniform over time). Here, the output voltage control unit 30 generates a switch driving signal of the switching unit 21 via the one or more NAND gates.

The converter unit 20 includes the switching unit 21 and a conversion unit 22. The switching unit 21 includes at least one switching device connected to a voltage source of the first voltage Vs. The conversion unit 22 includes a transformer 221 and a rectifying unit 222 (see, for example, FIG. 3). The transformer 221 converts the level of the first voltage Vs. The rectifying unit 222 generates the second voltage Vo by rectifying the voltage, the level of which was converted by the transformer 221.

The switching unit 21 includes a first switch Q1, a second switch Q2, and a resonant capacitor C_{H}. The first switch Q1 connects the voltage source of the first voltage Vs and the transformer 221 when it is in an ON operation. The second switch Q2 forms a current loop with the transformer 221 when it is in an ON operation.

The resonant capacitor CH is connected to a primary side of the transformer 221 and enables zero voltage switching of the first and second switches Q1 and Q2 of the switching unit 21 in resonance with an equivalent inductor of the primary side of the transformer 221.

The primary side of the transformer 221 is connected to the switching unit 21, and a secondary side of the transformer 221 is connected to the rectifying unit 222.

The output voltage control unit 30 includes an output voltage detecting unit 31, a pulse width modulation (PWM) control unit 32, and a gate signal generation unit 33 (see, for example, FIGS. 2 and 3). The output voltage detecting unit 31 detects the output voltage Vo outputted from the converter unit 20. The PWM control unit 32 generates a PWM control value in response to the output voltage Vo.

The gate signal generation unit 33 includes at least one NAND gate. By way of example, in one embodiment, the gate signal generation unit 33 includes three NAND gates G1, G2, and G3 (see, for example, FIG. 4). The gate signal generation unit 33 generates a switch driving signal for the switching unit 21 according to the PWM control value from the PWM control unit 32.

The output voltage detecting unit 31 receives the output voltage Vo across the resistor Ro and provides it to the PWM control unit 32. The output voltage detecting unit 31 may include a photo coupler for separating (or isolating) an output terminal (or output terminals) of the output voltage detecting unit 31 from input terminals thereof. That is, the input and output terminals of the output voltage detecting unit 31 are electrically separated (or isolated) by the photo coupler. Accordingly, the output voltage control unit 30 can be protected even when a surge voltage or a noise voltage is outputted as the output voltage Vo by the converter unit 20.

A switch driving signal outputted from the gate signal generation unit 33 is asymmetrically applied to the first switch Q1 and the second switch Q2. When a change of the output voltage Vo is generated by a load current Io (see, for example, FIG. 3), the change of the output voltage Vo is detected by the output voltage detecting unit 31, and then, an energy of the primary side of the transformer 221 is controlled by controlling a duty cycle, that is, by controlling ON/OFF times of the first switch Q1 and the second switch Q2. Thus, the output voltage Vo of the secondary side of the transformer 221 can be maintained to be more constant or uniform over time.

Here, there are times in which the ON pulses of the driving signal of the first switch Q1 and the driving signal of the second switch Q2 are not overlapping, that is, dead times t_{DEAD1} and t_{DEAD2} are present (see, for example, FIG. 5). This is to prevent the DC to DC converter from malfunctioning due to simultaneous (or concurrent) application of ON pulses to the first and second switches Q1 and Q2, e.g., at an ascending time and a descending time of the driving signal.

In one embodiment, the gate signal generation unit 33 includes a first gate G1, a second gate G2, and a third gate G3 which are NAND gates (see, for example, FIG. 4). PWM control values outputted from the PWM control unit 32 are inputted to respective input terminals of the first gate G1 and the second gate G2. An output of the second gate G2 is inputted to two input terminals of the third gate G3. Here, an output of the first gate G1 is used as the driving signal of the second switch Q2, and an output of the third gate G3 is used as the driving signal of the first switch Q1.

The gate signal generation unit 33 includes a first resistor R10, a second resistor R11, a first capacitor C5, and a second capacitor C6. The first resistor R10 is connected between an input terminal of the gate signal generation unit 33 and the two input terminals of the first gate G1. The second resistor R11 is connected between an input terminal of the gate signal generation unit 33 and a first input terminal of the second gate G2.

The first capacitor C5 is connected between the two input terminals of the first gate G1 and a ground terminal (as well as between the first resistor R10 and the ground terminal). The second capacitor C6 is connected between the first input terminal of the second gate G2 and the ground terminal (as well as between the second resistor R11 and the ground terminal). The dead times t_{DEAD1} and t_{DEAD2} between two gate signals V_{GS(Q1)} and V_{GS(Q2)} respectively inputted to the first switch Q1 and the second switch Q2 are determined by electrical parameters of the first resistor R10, the second resistor R11, the first capacitor C5, and the second capacitor C6.

In more detail, the dead times t_{DEAD1} and t_{DEAD2} are defined by Equations 1 and 2. Here, the dead time t_{DEAD1} indicates (or represents) the time between the OFF state of the second switch Q2 and the ON state of the first switch Q1, and the dead time t_{DEAD2} indicates the time between the OFF state of the first switch Q1 and the ON state of the second switch Q2. In these equations, the resistor and capacitor names are used to represent their respective resistances and capacitances.

$$\begin{matrix}{t}_{DEAD 2} = R 10 \times C 5 \times ln 2 & Equation 1 \\ \begin{matrix}{t}_{DEAD 1} = R 11 \times C 6 \times ln 2 - {t}_{DEAD 2} \\ = ( R 11 \times C 6 - R 10 \times C 5 ) \times ln 2\end{matrix} & Equation 2\end{matrix}$$

The switching unit 21 includes the first switch Q1, the second switch Q2, and the resonant capacitor C_{H}. The first switch Q1 is connected to the voltage source of the first voltage Vs and to the second switch Q2.

When the first switch Q1 is ON and the second switch Q2 is OFF, a current path is formed through the voltage source of the first voltage Vs, the resonant capacitor C_{H}, and the primary side of the transformer 221. Accordingly, energy is delivered from the voltage source of the first voltage Vs to the secondary side of the transformer 221 through the primary side of the transformer 221.

When the second switch Q2 is On and the first switch Q1 is OFF, a current path is formed through the resonant capacitor C_{H}, the second switch Q2, and the primary side of the transformer 221 due to energy accumulated in the resonant capacitor C_{H}. Here, the energy at the primary side of the transformer 221 is controlled by controlling the duty cycle, that is, by controlling the ON/OFF times of the first switch Q1 and the second switch Q2, and thus, the output voltage Vo at the secondary side of the transformer 221 is controlled. Here, to control the duty cycle, a switch driving signal outputted from the gate signal generation unit 33 is asymmetrically applied to the first switch Q1 and the second switch Q2.

In the output voltage control unit 30, when a change of the output voltage Vo is generated by a load current lo, the change of the output voltage Vo is detected by the output voltage detecting unit 31, and then, energy at the primary side of the transformer 221 is controlled by controlling the duty cycle, that is, ON/OFF times of the first switch Q1 and the second switch Q2, and thus, the output voltage Vo from the secondary side of the transformer 221 is maintained to be more uniform.

The switching devices Q1 and Q2 are operated to be turned ON/OFF by receiving an additional switching power, and can be metal oxide semiconductor (MOS) type field effect transistors (MOSFETs), insulating gate bipolar transistors (IGBTs), or thyristors. Also, in each of the switching devices Q1 and Q2, an anti-parallel diode pair for preventing a current flow after the power is turned off is provided to reduce a surge voltage and a ringing voltage, and a snub capacitor can be connected in parallel to the anti-parallel diode pair.

In further embodiments, the series connection of the switching devices Q1 and Q2 can be connected in parallel to the primary side of the transformer 221, and/or the rectifying unit 222 can be connected in parallel to the secondary side of the transformer 221. The second voltage Vo, which is maintained to be substantially uniform over time, is outputted from the output terminal of the rectifying unit 222 by the control of the output voltage control unit 30.

The timing of signals in the output voltage control unit 30 will now be described in more detail with reference to FIG. 5. Output voltages Vo outputted between the output terminals (i.e., between the terminals of the resistor Ro) of the converter unit 20 are detected at the output voltage detecting unit 31, and when the output voltages Vo are inputted to the PWM control unit 32, the PWM control unit 32 generates PWM control signals by comparing the output voltages Vo with a standard value.

When the PWM control signal is inputted to the gate signal generation unit 33, the signal at an input terminal (Point C) of the first gate G1 linearly increases or decreases as depicted in FIG. 5 according to the first resistor R10 and the first capacitor C5. When the signal at the input terminal (Point C) of the first gate G1 increases to be greater than an operation trigger level (see, for example, FIG. 5), an output of the first gate G1, that is, an output signal V_{GS(Q2)} as shown in FIG. 5 which is used as a control signal of the second switch Q2, transitions as shown in FIG. 5.

Similarly, a signal at an input terminal (Point A) of the second gate G2 linearly increases or decreases as depicted in FIG. 5 according to the second resistor R11 and the second capacitor C6. When the signal at the input terminal (Point A) of the second gate G2 increases to be greater than an operation trigger level (see, for example, FIG. 5), an output signal of the second gate G2, that is, an input signal (Point B) of the third gate G3 transitions as shown in FIG. 5. Here, an output of the third gate G3, that is, an output signal V_{GS(Q1)} as shown in FIG. 5, is used as a control signal of the first switch Q1.

As such, the energy at the primary side of the transformer 221 is controlled by the control of the duty cycle, that is, ON/OFF times of the first switch Q1 and the second switch Q2. As a result, the output voltage Vo of the secondary side of the transformer 221 is controlled according to the change of the energy at the primary side of the transformer 221. The duty cycle is controlled by the asymmetrical application of the switch driving signals V_{GS(Q1)} and V_{GS(Q2)} to the first switch Q1 and the second switch Q2, respectively.

Accordingly, when the output voltage Vo is changed, the output voltage Vo of the secondary side of the transformer 221 is maintained to be substantially uniform by controlling the duty cycle, that is, ON/OFF times of the first switch Q1 and the second switch Q2.

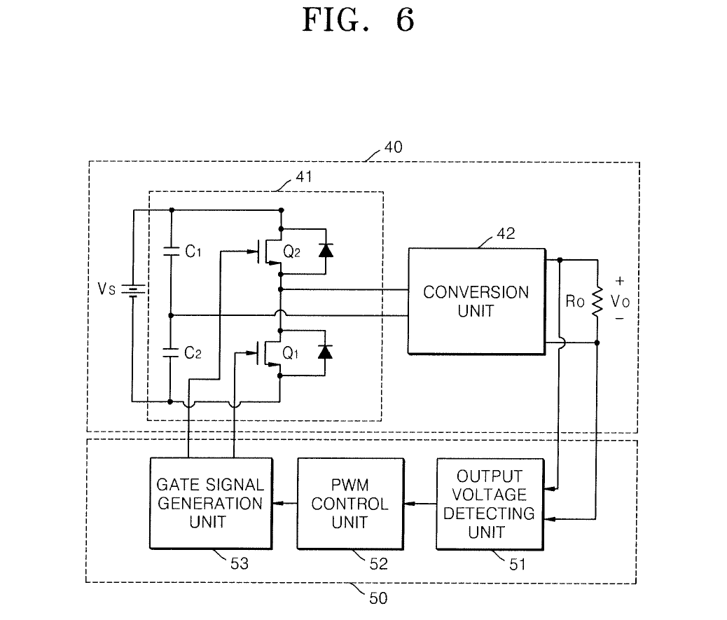

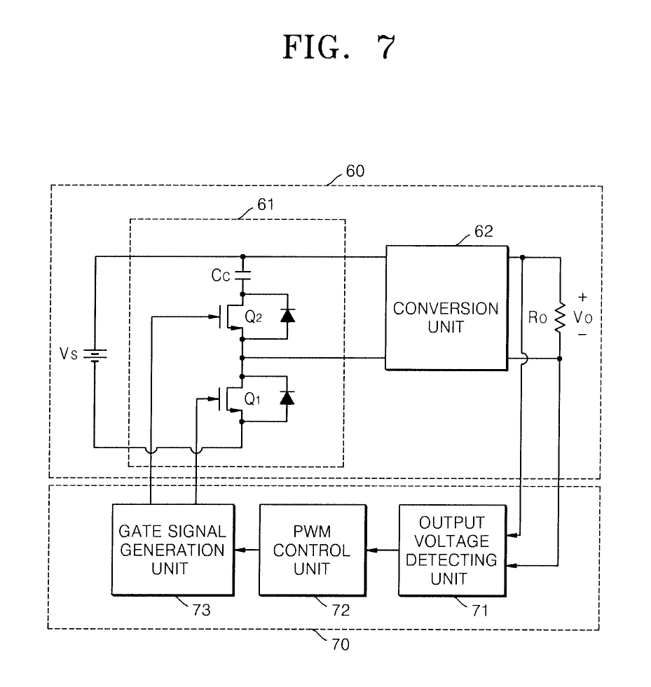

FIG. 6 is a schematic drawing illustrating an asymmetrical DC to DC converter that uses a NAND gate and includes a two-condenser type half bridge converter, according to another embodiment of the present invention. FIG. 7 is a schematic drawing illustrating an asymmetrical DC to DC converter that uses a NAND gate and includes an active clamp converter, according to another embodiment of the present invention.

Referring to FIGS. 6 and 7, the asymmetrical DC to DC converter that uses a NAND gate, according to respective embodiments of the present invention, includes a converter unit 40, 60 and an output voltage control unit 50, 70. The converter unit 40, 60 transforms a first voltage Vs of a first level to a second voltage Vo of a second level according to a switching operation of a switching unit 41, 61. The output voltage control unit 50, 70 maintains the level of the second voltage Vo to be substantially uniform over time. Here, the NAND gate of the output voltage control unit 50, 70 generates a switch driving signal for the switching unit 41, 61.

The converter unit 40, 60 includes the switching unit 41, 61 and a conversion unit 42, 62. The switching unit 41, 61 includes at least one switching device connected to a voltage source of the first voltage Vs. The conversion unit 42, 62 includes a transformer 421, 621 and a rectifying unit 422, 622. The transformer 421, 621 converts the level of the first voltage Vs. The rectifying unit 422, 622 generates a second voltage Vo by rectifying the voltage the level of which was converted by the transformer 421, 621.

The output voltage control unit 50, 70 includes an output voltage detecting unit 51, 71, a PWM control unit 52, 72, and a gate signal generation unit 53, 73. The output voltage detecting unit 51, 71 detects an output voltage Vo outputted from the converter unit 40, 60. The PWM control unit 52, 72 generates a PWM control value in response to the output voltage Vo.

The gate signal generation unit 53, 73 includes at least one NAND gate. In further embodiments, the gate signal generation unit 53, 73 includes three NAND gates G1, G2, and G3. The gate signal generation unit 53, 73 generates a switch driving signal for the switching unit 41, 61 in response to the PWM control value received from the PWM control unit 52, 72.

In FIG. 6, the converter unit 40 includes a two-condenser type half bridge converter. That is, the asymmetrical DC to DC converter of FIG. 6 is similar to the asymmetrical DC to DC converter of FIG. 2 and is different from the asymmetrical DC to DC converter depicted in FIG. 2 with respect to the converter unit 40. The output voltage control unit 50 has substantially the same configuration as the output voltage control unit 30 in FIG. 2, and thus, performs substantially the same function as the output voltage control unit 30.

In FIG. 7, the converter unit 60 includes an active clamp converter. That is, the asymmetrical DC to DC converter of FIG. 7 is similar to the asymmetrical DC to DC converter of FIG. 2 and is different from the asymmetrical DC to DC converter depicted in FIG. 2 with respect to the converter unit 60. The output voltage control unit 70 has substantially the same configuration as the output voltage control unit 30 in FIG. 2, and thus, performs substantially the same function as the output voltage control unit 30.

According to an asymmetrical DC to DC converter that uses a NAND gate according to embodiments of the present invention, an asymmetrical control circuit suitable for the DC to DC converter including an asymmetrical half bridge converter or an active clamp converter can be inexpensively and simply realized using NAND gates instead of using expensive dedicated chips.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. An asymmetrical DC to DC converter, comprising:
a converter unit comprising a switching unit and adapted to transform a first voltage having a first level to a second voltage having a second level according to a switching operation of the switching unit; and
an output voltage control unit comprising at least one NAND gate and adapted to control the second level of the second voltage to be substantially uniform,
wherein the output voltage control unit is further adapted to generate a driving signal for the switching unit via the at least one NAND gate.

2. The asymmetrical DC to DC converter of claim 1,
wherein the switching unit comprises at least one switching device connected to a voltage source for providing the first voltage, and
wherein the converter unit further comprises a conversion unit comprising a transformer adapted to change the first level of the first voltage to generate a changed voltage, and a rectifying unit adapted to generate the second voltage by rectifying the changed voltage.

3. The asymmetrical DC to DC converter of claim 2, wherein the at least one switching device of the switching unit comprises a first switch configured to connect the voltage source for providing the first voltage and the transformer by its ON operation and a second switch configured to form a current loop with the transformer by its ON operation.

4. The asymmetrical DC to DC converter of claim 2, wherein the switching unit further comprises a resonant capacitor connected to a primary side of the transformer such that the at least one switching device of the switching unit can be zero voltage switched in resonance with an equivalent inductor of the primary side of the transformer.

5. The asymmetrical DC to DC converter of claim 2, wherein a primary side of the transformer is connected to the switching unit and a secondary side of the transformer is connected to the rectifying unit.

6. The asymmetrical DC to DC converter of claim 1, wherein the output voltage control unit further comprises:
an output voltage detecting unit adapted to detect the second voltage outputted from the converter unit and to provide a voltage;
a PWM control unit adapted to generate a PWM control value in response to the voltage provided by the output voltage detecting unit; and
a gate signal generation unit comprising the at least one NAND gate and adapted to generate the driving signal for the switching unit in response to the PWM control value.

7. The asymmetrical DC to DC converter of claim 6, wherein the output voltage detecting unit is further adapted to electrically isolate the voltage provided by the output voltage detecting unit from the second voltage outputted from the converter unit.

8. The asymmetrical DC to DC converter of claim 7, wherein the output voltage detecting unit comprises a photo coupler adapted to isolate the voltage provided by the output voltage detecting unit from the second voltage outputted from the converter unit.

9. The asymmetrical DC to DC converter of claim 6,
wherein the at least one switching device of the switching unit comprises a first switch configured to connect a voltage source for providing the first voltage and the transformer by its ON operation and a second switch configured to form a current loop with the transformer by its ON operation, and
wherein the driving signal is configured to be asymmetrically inputted to the first switch and the second switch.

10. The asymmetrical DC to DC converter of claim 6,
wherein the at least one switching device of the switching unit comprises a first switch configured to connect a voltage source for providing the first voltage and the transformer by its ON operation and a second switch configured to form a current loop with the transformer by its ON operation, and
wherein the driving signal has a plurality of dead times during which ON signals for the first switch do not overlap with ON signals for the second switch.

11. The asymmetrical DC to DC converter of claim 6,
wherein the at least one NAND gate of the gate signal generation unit comprises a first gate and a second gate each adapted to receive the PWM control value and a third gate adapted to receive an output of the second gate, and
wherein the first gate, the second gate, and the third gate are NAND gates.

12. The asymmetrical DC to DC converter of claim 11,
wherein input terminals of the first gate and the second gate are adapted to receive the PWM control value, and
wherein two input terminals of the third gate are adapted to receive the output of the second gate.

13. The asymmetrical DC to DC converter of claim 12,
wherein the at least one switching device of the switching unit comprises a first switch adapted to connect a voltage source for providing the first voltage and the transformer by its ON operation and a second switch adapted to form a current loop with the transformer by its ON operation,
wherein the driving signal comprises a first driving signal for the first switch and a second driving signal for the second switch, and
wherein an output of the first gate is the second driving signal for the second switch and an output of the third gate is the first driving signal for the first switch.

14. The asymmetrical DC to DC converter of claim 12, wherein the gate signal generation unit further comprises:
a first resistor connected between an input terminal of the gate signal generation unit and the input terminals of the first gate; and
a second resistor connected between the input terminal of the gate signal generation unit and one of the input terminals of the second gate.

15. The asymmetrical DC to DC converter of claim 14, wherein the gate signal generation unit further comprises:
a first capacitor connected between a ground terminal and both the first resistor and the input terminals of the first gate; and
a second capacitor connected between the ground terminal and both the second resistor and the one of the input terminals of the second gate.

16. The asymmetrical DC to DC converter of claim 1, wherein the converter unit further comprises an active clamp converter.

17. An asymmetrical DC to DC converter comprising:
a converter unit comprising a switching unit and a half-bridge converter, and adapted to transform a first voltage having a first level to a second voltage having a second level according to a switching operation of the switching unit; and
an output voltage control unit comprising at least one NAND gate and adapted to control the second level of the second voltage to be substantially uniform,
wherein the output voltage control unit is further adapted to generate a driving signal for the switching unit via the at least one NAND gate.

18. The asymmetrical DC to DC converter of claim 17, wherein the output voltage control unit further comprises:
an output voltage detecting unit adapted to detect the second voltage outputted from the converter unit and to provide a voltage;
a PWM control unit adapted to generate a PWM control value in response to the voltage provided by the output voltage detecting unit; and
a gate signal generation comprising the at least one NAND gate and adapted to generate the driving signal for the switching unit in response to the PWM control value.

19. The asymmetrical DC to DC converter of claim 18, wherein the output voltage detecting unit further comprises a photo coupler adapted to isolate the voltage provided by the output voltage detecting unit from the second voltage outputted from the converter unit.

20. The asymmetrical DC to DC converter of claim 18,
wherein the converter unit further comprises a conversion unit comprising a transformer adapted to change the first level of the first voltage,
wherein the switching unit comprises a first switch configured to connect a voltage source for providing the first voltage and the transformer by its ON operation of and a second switch configured to form a current loop with the transformer by its ON operation, and
wherein the driving signal is configured to be asymmetrically applied to the first switch and the second switch.

21. The asymmetrical DC to DC converter of claim 18,
wherein the converter unit further comprises a conversion unit comprising a transformer adapted to change the first level of the first voltage,
wherein the switching unit comprises a first switch configured to connect a voltage source for providing the first voltage and the transformer by its ON operation and a second switch adapted to form a current loop with the transformer by its ON operation, and
wherein the driving signal has a plurality of dead times during which ON pulses for the first switch do not overlap with ON pulses for the second switch.

22. The asymmetrical DC to DC converter of claim 18,
wherein the at least one NAND gate of the gate signal generation unit comprises a first gate and a second gate each adapted to receive the PWM control value and a third gate adapted to receive an output of the second gate,
wherein the first gate, the second gate, and the third gate are NAND gates, and
wherein input terminals of the first gate and the second gate are adapted to receive the PWM control value and two input terminals of the third gate are adapted to receive the output of the second gate.

23. The asymmetrical DC to DC converter of claim 22,
wherein the converter unit further comprises a conversion unit comprising a transformer adapted to change the first level of the first voltage,
wherein the switching unit comprises a first switch configured to connect a voltage source for providing the first voltage and the transformer by its ON operation and a second switch configured to form a current loop with the transformer by its ON operation,
wherein the driving signal comprises a first driving signal for the first switch and a second driving signal for the second switch, and
wherein an output of the first gate is the second driving signal for the second switch and an output of the third gate is the first driving signal for the first switch.

24. The asymmetrical DC to DC converter of claim 23, wherein the gate signal generation unit further comprises:
a first resistor connected between an input terminal of the gate signal generation unit and the input terminals of the first gate;
a second resistor connected between the input terminal of the gate signal generation unit and one of the input terminals of the second gate;
a first capacitor connected between a ground terminal and both the first resistor and the input terminals of the first gate; and
a second capacitor connected between the ground terminal and both the second resistor and the one of the input terminals of the second gate.
